(19) United States
(12) Patent Application Publication
(10) Pub. No.: US 2005/0099525 A1
(43) Pub. Date: May 12, 2005

(54) Telescope main body and telescope

(75) Inventors: Makoto Mogamiya, Tokyo (JP); Toshio Masuda, Tokyo (JP)

Correspondence Address: GREENBLUM & BERNSTEIN, P.L.C., 1950 ROLAND CLARKE PLACE, RESTON, VA, 20191, US

(73) Assignee: PENTAX Corporation, Tokyo (JP)

(21) Appl. No.: 10/981,796

(22) Filed: Nov. 5, 2004

(30) Foreign Application Priority Data
Nov. 6, 2003 (JP) 2003-377602

(51) Int. Cl. H04N 5/232

(52) U.S. Cl. 348/345

(57) ABSTRACT

A telescope main body, which includes an objective optical system, a focusing system including a focus adjusting member to be manipulated and a focusing lens, an imaging device, and a beam splitter. The telescope main body further includes a focus driving system that relatively moves an image forming position of the object image with respect to a receiving surface of the imaging device, a detecting system that detects brightness of ambient light, and a controller that controls the imaging device and the focus driving system. The controller adjusts the image forming position relative to the receiving surface based on the brightness of the ambient light detected by the detecting system.

### BACKGROUND OF THE INVENTION

The present invention relates to a telescope main body and a telescope having a digital camera.

A telescope (spotting scope) with a digital camera is known, which is capable of shooting an electronic image that is the same as a visual image viewed through an eyepiece thereof. Such a telescope is disclosed, for example, in a Japanese Utility Model Publication No. 3074642 (hereafter, referred to as a document 1). The telescope with a digital camera is provided with a beam splitter for splitting a light beam that has passed through an objective optical system and a focusing lens, and leading one of the split beam to an ocular optical system and the other to an imaging device such as a CCD (charge coupled device) imaging device.

Such a telescope with a camera is configured such that when a visual image viewed through an eyepiece is focused by use of a focus ring by a user, an object image formed through the object optical system also coincides with a receiving surface of the imaging optical system.

However, there is a case where an image (an electronic image) out of focus is photographed in dark ambient light conditions, for example, night.

### SUMMARY OF THE INVENTION

The present invention is advantageous in that it provides an telescope with a digital camera configured to obtain properly focused images regardless of ambient light conditions.

According to an aspect of the invention, there is provided a telescope main body, which is provided with an objective optical system, a focusing system including a focus adjusting member to be manipulated for focusing and a focusing lens which moves along a direction of an optical axis by operation of the focus adjusting member, an imaging device which captures an object image formed through the objective optical system and the focusing lens, and a beam splitter which splits an optical path through the focusing lens into a first optical path directed to the imaging device and a second optical path directed to an ocular optical system provided in an eyepiece which is detachably attached to the telescope main body.

Further, the telescope main body is provided with a focus driving system that relatively moves an image forming position of the object image with respect to a receiving surface of the imaging device, a detecting system that detects brightness of ambient light, and a controller that controls the imaging device and the focus driving system. The controller adjusts the image forming position relative to the receiving surface based on the brightness of the ambient light detected by the detecting system.

With this configuration, properly focused images (still images) can be obtained regardless of the brightness of ambient light.

Optionally, the controller may adjust the image forming position relative to the receiving surface to correct a position shift of the focusing lens caused by a fact that a position of the focusing lens determined when focus adjustment of a visual image formed through the ocular optical system by use of the focus adjusting member is attained by a user changes depending on a change of a peak wavelength of spectral luminous efficiency with brightness of the ambient light.

Still optionally, the controller may have a threshold value, and may adjust the image forming position relative to the receiving surface depending on whether the brightness of the ambient light detected by the detecting system is larger than the threshold value.

Still optionally, the detecting system may include a photometric device.

In a particular case, the photometric device may be located to detect a portion of light passed through the objective optical system.

In a particular case, the photometric device may be located to directly receive external light.

In a particular case, the detecting system may detect the brightness of the ambient light based on output signals from the imaging optical system.

Optionally, the telescope main body may include a focus adjusting optical system located on the second optical path.

Still optionally, the focus driving system may move the focus adjusting optical system with respect to the imaging device to relatively move the image forming position with respect to the receiving surface.

Still optionally, an imaging optical system may be formed by optical components including the objective optical system and the focusing lens and located between the objective optical system and the receiving surface of the imaging device. In this case, a focal length of the imaging optical system may be not less than 800 mm on the basis of a 35 mm film.

According to another aspect of the invention, there is provided a telescope, which is provided with an ocular optical system, an objective optical system, a focusing system including a focus adjusting member to be manipulated for focusing and a focusing lens which moves along a direction of an optical axis by operation of the focus adjusting member, an imaging device which captures an object image formed through the objective optical system and the focusing lens, and a beam splitter which splits an optical path through the focusing lens into a first optical path directed to the imaging device and a second optical path directed to the ocular optical system.

Further, the telescope is provided with a focus driving system that relatively moves an image forming position of the object image with respect to a receiving surface of the imaging device, a detecting system that detects brightness of ambient light, and a controller that controls the imaging device and the focus driving system. The controller adjusts the image forming position relative to the receiving surface based on the brightness of the ambient light detected by the detecting system.

With this configuration, properly focused images (still images) can be obtained regardless of the brightness of ambient light.

### BRIEF DESCRIPTION OF THE ACCOMPANYING DRAWINGS

FIG. 1 is a perspective front view showing a telescope main body according to an embodiment of the present invention;

FIG. 2 is a perspective rear view showing the telescope main body of FIG. 1;

FIG. 3 is a cross-sectional side view showing the telescope main body of FIG. 1;

FIG. 4 is a perspective exploded view showing an optical system of a telescope according to the embodiment of the present invention;

FIG. 5 is a side view showing a prism unit viewed from an opposite side of FIG. 3;

FIG. 6 is a block diagram showing a configuration of the telescope main body of FIG. 1;

FIG. 7 is a flowchart showing a main controlling operation of the telescope main body according to the embodiment of the present invention; and

FIG. 8 is a graph illustrating spectral luminous efficiency, spectral sensitivity of a CCD imaging device and spectral transmittance of an infrared cut filter.

### DETAILED DESCRIPTION OF THE EMBODIMENTS

Referring to the accompanying drawings, preferable embodiments of an optical instrument with a digital camera according to the present invention will be described hereunder. As examples of the optical instrument, a telescope main body and a spotting scope is explained hereafter.

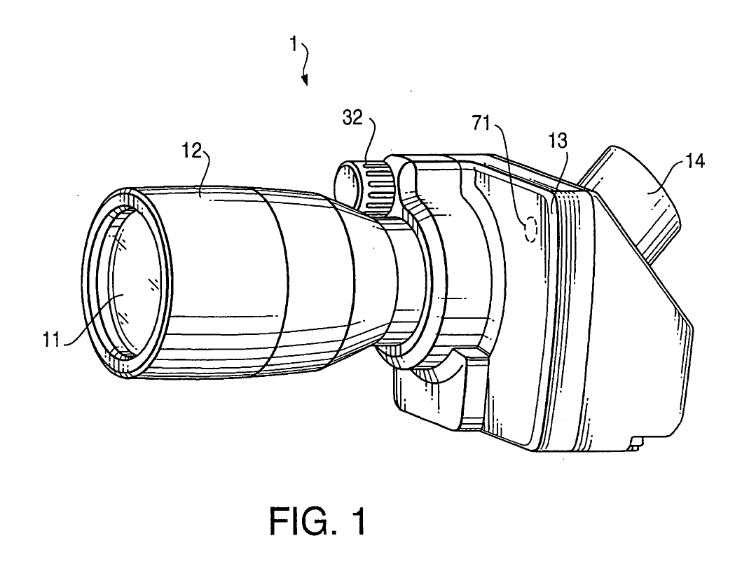

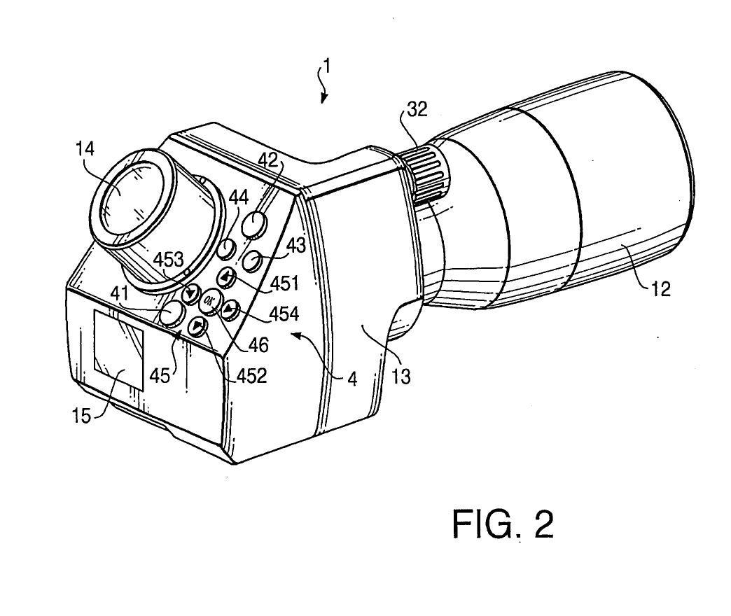

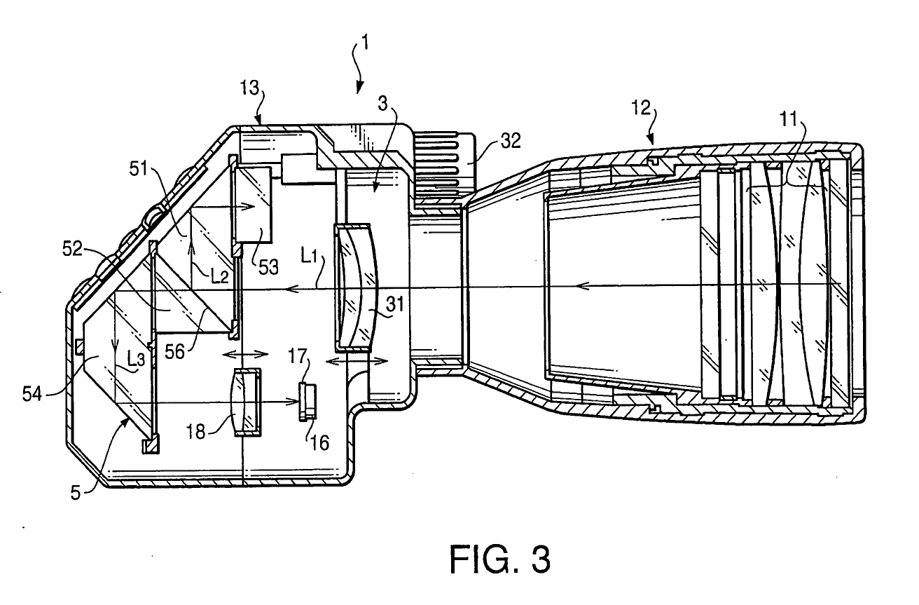

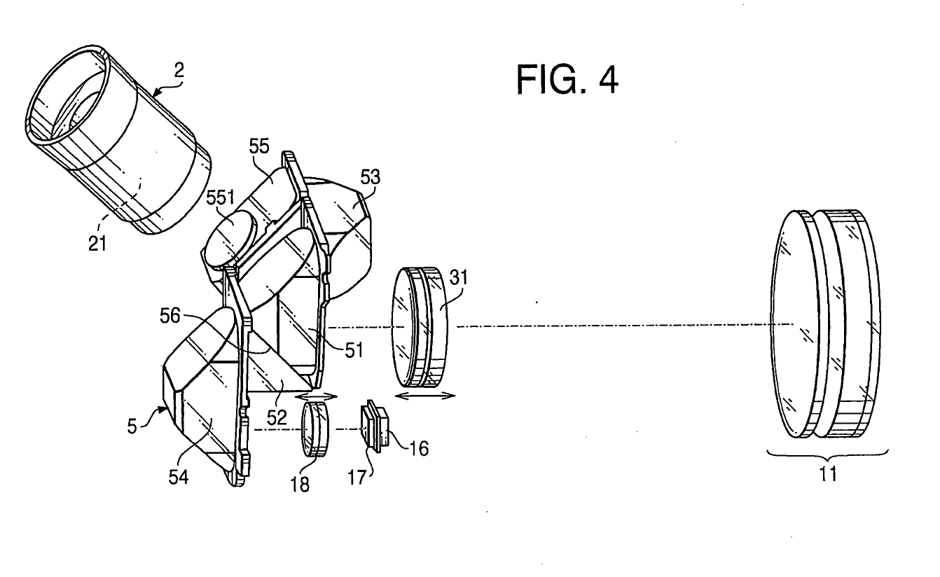

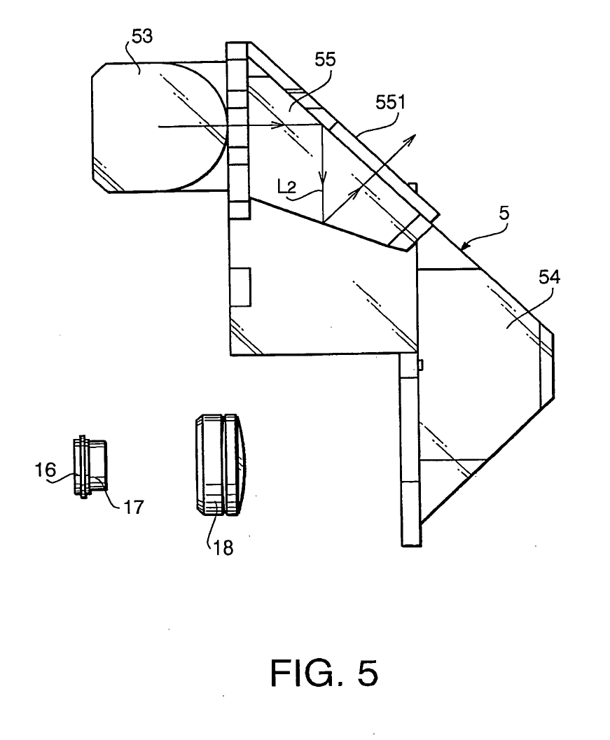

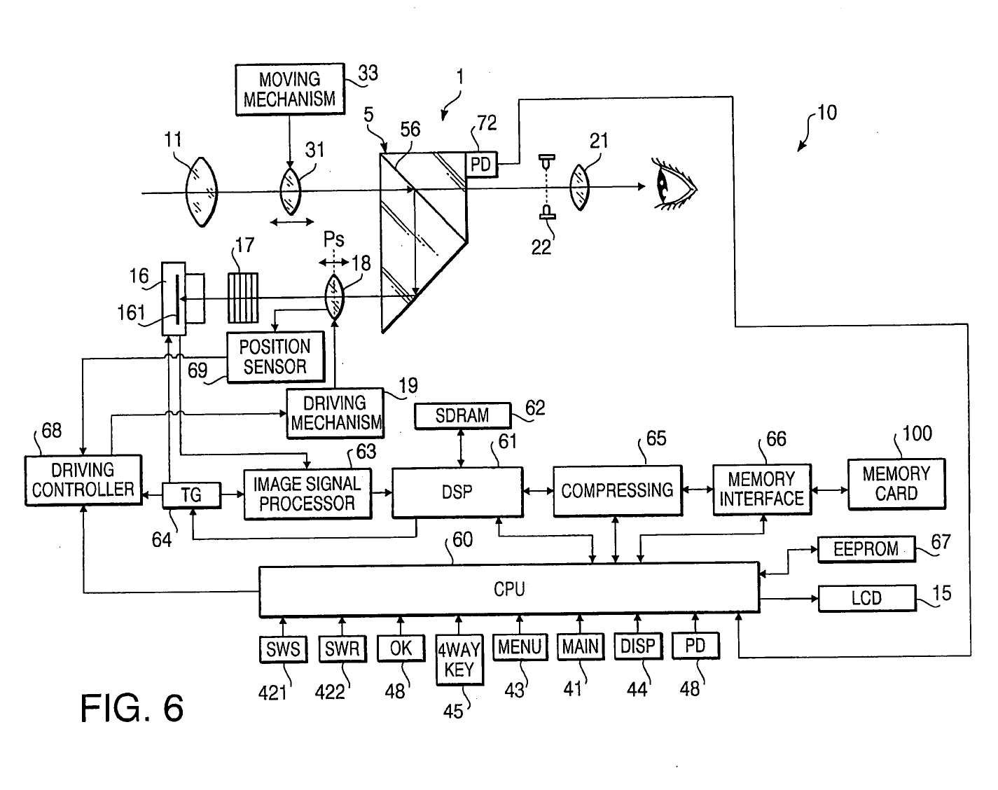

FIG. 1 is a perspective front view showing a telescope main body according to the embodiment of the present invention; FIG. 2 is a perspective rear view showing the telescope main body of FIG. 1; FIG. 3 is a cross-sectional side view showing the telescope main body of FIG. 1; FIG. 4 is a perspective exploded view showing an optical system of the spotting scope according to the present invention; FIG. 5 is a side view showing a prism unit viewed from an opposite side of FIG. 3; and FIG. 6 is a block diagram showing a configuration of the telescope main body of FIG. 1.

The telescope main body 1 according to the embodiment shown in these drawings is to be combined with an eyepiece 2, to thereby constitute a spotting scope 10 (see FIGS. 4 and 6). The spotting scope 10 can be suitably utilized for various purposes, typically for bird watching.

As shown in FIG. 1, the telescope main body 1 is provided with a lens barrel 12 containing therein an objective optical system 11, and a casing 13 located at a base portion of the lens barrel 12. The casing 13 is provided with a focusing ring 32 rotatably disposed in an upper region of a front face thereof, for serving as a focus adjusting device. The casing 13 is further provided, on the upper region of the front face thereof, with a photometric sensor 71 which detects intensity of ambient light. The photometric sensor 71 receives ambient light (i.e., light incident thereon without passing through the objective optical system 11) and outputs a signal of which amplitude is responsive to the intensity of ambient light.

Referring to FIG. 2, the casing 13 is provided, on a rear face thereof, with an eyepiece mounting base 14 to which the eyepiece 2 can be detachably mounted, a display panel 15 and various operating buttons 4.

On the eyepiece mounting base 14, the eyepiece 2 containing therein an ocular optical system 21 as shown in FIG. 4 can be detachably mounted. Replacing the eyepiece 2 with another having a different focal length can change a magnification of the spotting scope 10. Also, the eyepiece mounting base 14 accepts a variable focus type (zoom type) eyepiece.

While the drawings show an angle type spotting scope in which an optical axis of the eyepiece 2 mounted on the eyepiece mounting base 14 is upwardly inclined with respect to an optical axis of the objective optical system 11 by a predetermined angle, the scope of the present invention is not limited to such type. The present invention may also be applied to a straight type spotting scope in which the both optical axes are parallel to each other.

In this embodiment, the eyepiece 2 is detachably attached to the telescope main body 1, the telescope main body 1 may alternatively be configured such that an eyepiece Is integrally formed with a telescope main body.

The display panel 15 is constituted of for example a liquid crystal display device. The display panel 15 can display a menu screen, a setting screen of different modes, an image captured by a CCD (Charge Coupled Device) imaging device 16 to be described later, and so forth.

Referring to FIG. 2, the operating buttons 4 include a main switch 41 for turning on and off the power, a release button 42, a menu key 43, a display key 44 for switching on and off the display panel 15, an up key 451, a down key 452, a left key 453 and a right key 454 respectively for moving a cursor displayed on the display panel 15, and an OK button 46 for entering a selected item.

Referring to FIG. 3, the lens barrel 12 contains the objective optical system 11 in the proximity of a front end portion thereof. Also, a focusing lens (focus adjusting lens) 31 is coaxially placed with respect to the objective optical system 11, in the casing 13. The focusing lens 31 moves along a direction of the optical axis by a manipulation of the focusing ring 32, so as to adjust a focus. A focusing lens moving mechanism 33 (not shown in FIG. 3) for converting a rotational movement of the focusing ring 32 into a rectilinear movement of the focusing lens 31 may be a barrel cam mechanism or a feed screw mechanism etc. The focusing lens 31, the focusing ring 32 and the focusing lens moving mechanism 33 constitute a focusing system 3.

In the casing 13, a prism unit 5 is disposed behind the focusing lens 31. The prism unit 5 includes a first right-angle prism 51, a second right-angle prism 52, a third right-angle prism 53, a fourth right-angle prism 54 and a prism 55.

A short side surface of the first right-angle prism 51 and the long side surface of the second right-angle prism 52 are joined, and the joint plane constitutes a beam splitter 56. Also, as shown in FIG. 4, the prism 55 is provided with an emergence plane 551, through which a light beam proceeds toward the ocular optical system 21 (eyepiece mounting base 14).

Referring further to FIG. 3, a light beam that has passed through the objective optical system 11 and the focusing lens 31 first enters the first right-angle prism 51. An optical path L1 of this light beam is split at the beam splitter 56 into a first optical path L2 directed to the ocular optical system 21 and a second optical path L3 directed to the CCD imaging device 16.

The first optical path L2 directed to the ocular optical system 21 turns its direction by 180 degrees because of reflection at the beam splitter 56 as well as the other short side plane of the first right-angle prism 51. As shown in FIG. 5, the first optical path L2 is then reflected twice in the third right-angle prism 53 thus to turn its direction again by 180 degrees, and further reflected twice in the prism 55, to thereby upwardly incline and to finally proceed to the ocular optical system 21 through the emergence plane 551.

The first right-angle prism 51 and the third right-angle prism 53 constitute an erecting optical system (porro prism). For this reason an erected image can be observed through the eyepiece 2.

Back to FIG. 3, the second optical path L3 directed to the CCD imaging device 16 passes through the beam splitter 56 to enter the fourth right-angle prism 54, and is reflected twice in the fourth right-angle prism 54 to thereby turn its direction by 180 degrees and to proceed forward.

The casing 13 also accommodates therein the CCD imaging device 16, an optical filter unit 17 and a reducing optical system 18.

The CCD imaging device 16 is disposed at a position appropriate for receiving a light beam that has come along the second optical path L3, to thereby capture an image obtained through the objective optical system 11 and the focusing lens 31. As a result of such configuration, the spotting scope 10 can shoot an electronic image identical to a visual image viewed through the eyepiece 2, with the CCD imaging device 16. It should be noted that another imaging device such as a CMOS sensor or the like may be used in place of the CCD imaging device 16.

The optical filter unit 17 is attached to the CCD imaging device 16 so as to face a receiving surface 161 thereof. The optical filter unit 17 is formed by a lamination of an optical low-pass filter and an infrared cut filter. The optical low-pass filter serves to reduce a spatial frequency component close to a sampling spatial frequency determined by a pixel spacing of the CCD imaging device 16, out of a spatial frequency of a light beam of an object. The optical low-pass filter serves to prevent emergence of a moire, and the infrared cut filter serves to exclude an infrared frequency component. Providing the infrared cut filter permits preventing the CCD imaging device 16 from receiving an infrared light beam which is invisible to human eyes.

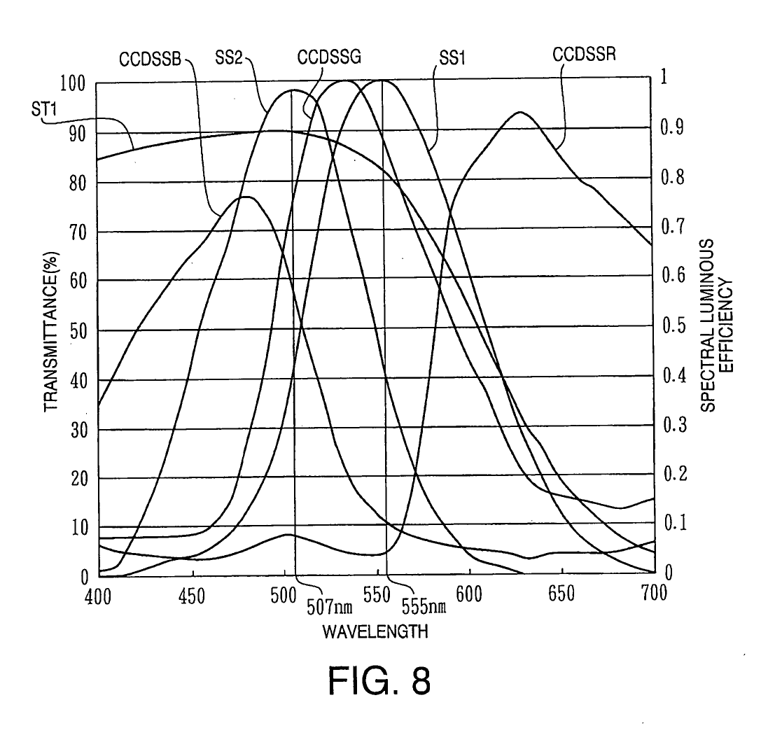

For example, the infrared cut filter may have optical performance shown in FIG. 8 as spectral transmittance STI. In FIG. 8, a spectral sensitivity of the CCD imaging device 16 (a relative sensitivity of blue pixels CCDSSB, a relative sensitivity of green pixels CCDSSG, and a relative sensitivity of red pixels CCDSSR in FIG. 10), is also indicated. The CCD imaging device 16 has relatively high sensitivity for blue and red light as well as green light.

The reducing optical system 18 is placed between the fourth right-angle prism 54 and the combination of the CCD imaging device 16 and the optical filter unit 17. A light beam from the focusing lens 31 that has proceeded along the second optical path L3 is downscaled by the reducing optical system 18 so as to fit a size of the CCD imaging device 16, to thereby form an image on the receiving surface 161 of the CCD imaging device 16.

As described above, the telescope main body 1 is provided with the imaging optical system for the CCD imaging device 16, constituted of the entire optical system disposed between the objective optical system 11 to the receiving surface 161 (see FIG. 6) of the CCD imaging device 16, inclusive of the former, namely the objective optical system 11, the focusing lens 31, the beam splitter 56, the reducing optical system 18 and the optical filter unit 17.

It is preferable that the imaging optical system has a focal length of not less than 800 mm on the basis of a 35 mm film. Here, a focal length on the basis of a 35 mm film means a focal length that forms an object image of a same picture angle on the receiving surface of the CCD imaging device 16, assuming that an effective receiving area of the CCD imaging device 16 is enlarged to the exposure area of a 35 mm silver halide film (36 mm×24 mm).

On the other hand, an upper limit of the focal length of the imaging optical system is not specifically determined, however from the viewpoint of a practical use, a maximum focal length of the imaging optical system of the telescope according to the embodiment of the present invention may be approx. 20000 mm on the basis of a 35 mm film.

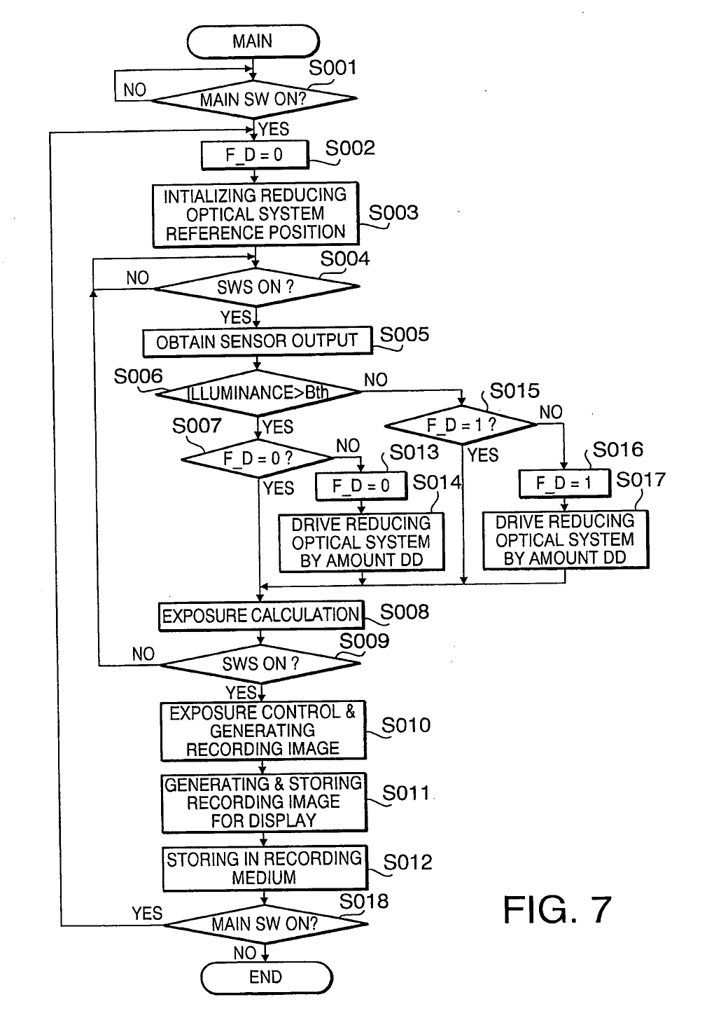

The reducing optical system 18 is movably disposed, and is driven by a reducing optical system driving mechanism 19 so as to move in a direction of the optical axis (Ref. FIG. 7). The reducing optical system driving mechanism 19 according to the embodiment includes, though not shown in details, a feed screw and a stepping motor for rotating the feed screw, to thereby rectilinearly drive the reducing optical system 18. Operation of the reducing optical system driving mechanism 19 is controlled by a reducing optical system driving controller 68.

When the reducing optical system 18 moves in a direction of the optical axis, an image forming position of an object image formed through the objective optical system 11 and the focusing lens 31 moves with respect to the receiving surface 161 of the CCD imaging device 16, in a direction of the optical axis. Accordingly, the reducing optical system 18 serves as a focus adjusting optical system for the CCD imaging device 16, which adjusts a focus of an object image on the receiving surface 161 of the CCD imaging device 16. Likewise, the reducing optical system driving mechanism 19 serves as a focus driving system which relatively moves the image forming position of the object image with respect to the receiving surface 161 in a direction of the optical axis (i.e., the optical axis of the reducing optical system 18).

Here, the focus driving system according to the embodiment of the present invention may be constituted, without limitation to the above, so as to move the CCD imaging device 16 in a direction of the optical axis, thus to relatively move the image forming position with respect to the receiving surface 161. In this embodiment the reducing optical system 18 is moved for focus adjustment, since such design better simplifies the structure.

Referring to FIG. 6, the reducing optical system 18 is provided with a position sensor 69 for detecting that the reducing optical system 18 is at a reference position Ps. An output signal of the position sensor 69 is input to the reducing optical system driving controller 68. When the reducing optical system 18 is at the reference position Ps, the receiving surface 161 is located at a position that is optically equivalent to a field frame 22 (target focus position) of the eyepiece 2.

Now referring to FIG. 6, from the viewpoint of electric configuration, the telescope main body 1 is provided with a CPU (Central Processing Unit) 60, a DSP (Digital Signal Processor) 61, an SDRAM (Synchronous Dynamic Random Access Memory) 62, an image signal processor 63, a timing generator 64, an image data compressor 65, a memory interface 66, and an EEPROM (Electrically Erasable Programmable Read-Only Memory) 67. In addition, the casing 13 accommodates therein a slot (not shown) in which a memory card (storage medium) 100 can be loaded.

The CPU 60 serves for integrally controlling the telescope main body 1 based on a preinstalled program and input signals from the operating buttons etc., and performs various controlling operations such as a photographic control, a control over the reducing optical system driving controller 68 and so forth.

The DSP 61 is engaged in driving control of the CCD imaging device 16 and integral control of image processing and storing, including generation of image data based on a pixel signal from the CCD imaging device 16, compression of the image data, storing the image data in the memory card 100, etc., through mutual communication with the CPU 60 for collaboration in these jobs.

The SDRAM 62 includes operating regions for image data generation etc. and regions for the display panel 15 etc., which are determined in advance.

The timing generator 64 is controlled by the DSP 61, to output a sample pulse etc. to the CCD imaging device 16, the image signal processor 63 and the reducing optical system driving controller 68, for controlling an operation thereof.

On the display panel 15, a live view (monitor display) of a real-time image captured by the CCD imaging device 16, which is the same as the visual image viewed through the eyepiece 2, is displayed as described in the following process. The object image formed on the receiving surface 161 of the CCD imaging device 16 is photoelectrically converted into electrical charge data, and such charge data (signal) is sequentially read out from the CCD imaging device 16 with a portion corresponding to a predetermined number of pixels thinned out, for reproducing a live view image.

Further, the signal undergoes a correlative double sampling (CDS), automatic gain control (AGC) and analog/digital conversion in the image signal processor 63, to then be input to the DSP 61. In the DSP 61, a predetermined signal processing including color processing and gamma correction etc. is performed on the input signal, to thereby generate a live view image data (luminosity signal Y, two color difference signals Cr, Cb).

The live view image data includes a fewer number of pixels (because of the thinning out) than the number of effective pixels of the CCD imaging device 16, in accordance with the number of pixels of the display panel 15, so that the display panel can display an image according to such live view image data. The generation of the live view image data is periodically updated each time the data is read out from the CCD imaging device 16, so that the image is displayed on the display panel 15 as a real-time motion picture.

The spotting scope 10 configured as above is designed such that a visual image viewed through the eyepiece 2 is to be recognized as correctly focused when an image forming position (aerial image) of the visual image has reached a position of the field frame 22 by manipulation of the focusing ring 32. In other words, the user is expected to manipulate the focusing ring 32 for focusing purpose such that an image formed at a position of the field frame 22 (target focus position) becomes clearly seen.

By pressing the release button 43 when the user views a visual image to be photographed, the user can store an electronic image identical to the visual image viewed through the eyepiece 2. As already described, since the receiving surface 161 of the CCD imaging device 16 is at a position optically equivalent to the position of the field frame 22 (target focus position) when the reducing optical system 18 is at the reference position Ps, the same object image is also formed on the receiving surface 161 of the CCD imaging device 16 once the focus is adjusted as above. Therefore, upon shooting the image under such state, a correctly focused picture is supposed to be obtained.

As already described, a conventional telescope with a digital camera has a problem that there may be a case where an electronic image out of focus is captured under dark ambient light conditions. The inventor of the present invention found that such a problem is caused by the following reasons.

An object image formed through the imaging optical system has a longitudinal spherical aberration. That is, an image forming position varies in a direction of an optical axis among wavelengths of light passing therethrough. Since the longitudinal spherical aberration varies in proportion to a focal length of the imaging optical system, the spotting scope 10 has a relatively large longitudinal spherical aberration due to its long focal length. That is, the spotting scope 10 has a relatively large focus position shift among color components (wavelengths).

Sensitivity of human eyes varies with a wavelength of light. As can be seen from a spectral luminous efficiency for photopic vision SS1 shown in FIG. 8, human eyes have highest sensitivity to light having a wavelength at the vicinity of 555 nm under bright ambient light conditions. Therefore, in bright ambient light conditions, the user feels that the focus adjustment by the focusing ring 32 is attained when an image forming position of an object having a color component corresponding to a wavelength of about 555 nm coincides with the field frame 22 of the eyepiece 2.

The spectral luminous efficiency varies with brightness of ambient light. As can be seen from a spectral luminous efficiency for scotopic vision SS2 shown in FIG. 8, human eyes have highest sensitivity to light having a conditions. Therefore, in dark ambient light conditions, the user feels that the focus adjustment by the focusing ring 32 is attained when an image forming position of an object having a color component corresponding to a wavelength of about 507 nm coincides with the field frame 22 of the eyepiece 2.

For this reason, a position of the focusing lens 31 after the focus adjustment by the focusing ring 32 varies between the dark ambient light conditions and the bright ambient light conditions even though the focus adjustment is conducted for an observation target object having the same object distance. The conventional telescope with a digital camera is configured such that an object image coincides with a receiving surface of a CCD imaging device when focus adjustment is conducted under the bright ambient light. Therefore, there may be a case where the conventional telescope with a digital camera captures an image out of focus under dark ambient light.

The telescope main body 1 (the spotting scope 10) is configured as follows based on the above mentioned fact found by studies of the inventor of the present invention. That is, the telescope main body 1 is configured to detect brightness of ambient light by the photometric sensor 71 and to locate the reducing optical system 18 at the reference position Ps in bright ambient light conditions and a corrected position Pc in dark ambient light conditions. By such a configuration, it becomes possible to obtain properly focused images (electronic images) regardless of brightness of ambient light.

A correction amount DD which corresponds to a distance between the reference position Ps and the corrected position Pc is stored, for example, in the EEPROM 67 in the telescope main body 1, and is used to move the reducing optical system 18 to the corrected position PC in dark ambient light conditions. The correction amount DD is determined to correct a positional difference of the focusing lens 31 between the condition in which the user has the spectral luminous efficiency for photopic vision SS1 and the condition in which the user has the spectral luminous efficiency for scotopic vision SS2, considering optical performance (i.e., a longitudinal spherical aberration) of the imaging optical system regarding.

Next, main controlling operation of the telescope main body 1 will be described in detail with reference to FIG. 7. FIG. 7 is a flowchart illustrating the main controlling operation of the telescope main body 1.

Once the main switch 41 is pressed in an off state to turn the power on (step S001), and the CPU 60 is activated and reads in various set values (step S002). The CPU 60 uses a flag F_D to check whether the reducing optical system 18 is moved to the reference position Ps from the corrected position Pc. A value 0 of the flag F_D indicates that the reducing optical system 18 is at the reference position Ps, and a value 1 of the flag F_D indicates that the reducing optical system 18 is at the corrected position Ps. In step S002, the flag F_D is reset to 0.

Next, in step S003, the CPU 60 drives the reducing optical system driving mechanism 19 through the reducing optical system driving controller 68, to thereby move the reducing optical system 18 to the reference position Ps, and performs the initialization.

Here, the CPU 60 controls, upon moving the reducing optical system 18, a driving direction K and a driving distance a so as to recognize an absolute position (actual position) of the reducing optical system 18. The driving direction K is defined as plus (+) for a predetermined direction (for example a direction separating from the CCD imaging device 16) and minus (−) for the opposite direction, for controlling purpose. The driving distance A can be controlled according to the number of driving pulses provided to a stepping motor of the reducing optical system driving mechanism 19.

Also, the reducing optical system driving mechanism 19 is designed so as to move the reducing optical system 18 by half a length of a focal depth of the imaging optical system, with each input of a driving pulse. For example, in the case where a focal depth of the imaging optical system is 12 μm, the reducing optical system 18 moves 6 μm with an input of a driving pulse to the reducing optical system driving mechanism 19, and two driving pulses are necessary in order to move the reducing optical system 18 over a distance equal to the focal depth.

It is noted that before a shooting operation (i.e. an operation from step S004), the user manipulates the focusing ring 32 viewing the visual image through the eyepiece 2 so that the visual image is properly focused at the position of the field frame 22. When the release button 42 is pressed by half and a photometric switch 421 is thereby turned on (step S004:YES), the CPU 60 obtains an output signal of the photometric sensor 71 (S005). Then, the CPU checks whether the intensity defined by the output signal of the photometric sensor 71 exceeds a threshold value Bth (S006).

The value Bth is defined as an output value of the photometric sensor corresponding to a threshold between a brightness range in which a person has the spectral luminous efficiency for photopic vision SS1 and a brightness range in which a person has the spectral luminous efficiency for scotopic vision SS2. Typically, the threshold value Bth corresponds to illuminance of about 10-2 lux. If the illuminance obtained by the photometric sensor 71 is larger than the threshold value Bth (illuminance>Bth), a person has the spectral luminous efficiency for photopic vision SS1. If the illuminance obtained by the photometric sensor 71 is lower than or equal to the threshold value Bth (illuminance≦Bth), a person has the spectral luminous efficiency for scotopic vision SS2.

If it is determined in step S006 that the illuminance is larger than the threshold value Bth (S006:YES), the CPU 60 check whether the flag F_D is 0, i.e., whether the reducing optical system 18 is at the reference position Ps (S007). If the F_D is 0 (S007:YES), the CPU 60 performs exposure calculation (S008).

If it is determine in step S007 that the flag F_D is 1 (S007:NO), control proceeds to step S013 to reset the flag F_D to 0. Then, the CPU 60 drives the reducing optical system 18 back by the correction amount DD to the reference position Ps (S014). After the step S014, the exposure calculation is performed in step S008.

In step S009, the CPU 60 checks whether the release button 42 is fully pressed. When the release button 42 is pressed all the way down and a release switch 422 is thereby turned, (step S009:YES), the CPU 60 instructs the DSP 61 to execute a real exposure. When the release button 42 is not fully pressed (S009:NO), control returns to step S004.

The DSP 61, upon receipt of the instruction of a real exposure, performs unwanted charge discharging control and exposure control (charge storage time control) etc. for the CCD imaging device 16, and then reads out charge data through the image signal processor 63, from the CCD imaging device 16 without thinning out the pixels and temporarily stores the data in the SDRAM 62. Then the DSP 61 carries out a predetermined signal processing with respect to the charge data read out of the SDRAM 62, to thereby generate an original still image data for recording, constituted of the full number of pixels (step S010).

Further, the DSP 61 thins out the pixels from the generated original still image data for recording to generate a screen nail of a still image for displaying (for example 640×480 pixels), and displays the screen nail on the display panel 15 for a predetermined period of time (step S011). The DSP 61 also compresses the generated original still image data for recording in the image data compressor 65. Then, the compressed image data (e.g., JPEG or TIFF format data) is stored in the memory card 100 through the memory interface 66 (step S012).

In step S018 the status of the main switch 41 is checked. When the main switch 41 is pressed again and thereby the power is turned off (S018:NO), the main controlling operation is terminated. When the main switch is ON (S018:YES), control returns to step S002.

By the above mentioned operation (S007 through S012), a properly focus image is obtained under bright ambient light conditions since the reducing optical system 18 is located at the reference position Ps.

On the other hand, if it is determined in step S006 that the illuminance is lower than or equal to the threshold value Bth (S006:NO), operation for moving the reducing optical system 18 to the corrected position PC is performed because in this case the position of the focusing lens 31 is shifted relative to the position in the bright ambient light conditions.

More specifically, in step S015 it is judged whether or not the flag F_D is 1. If the flag F_D is not 1 (S015:NO), the CPU 60 changes the value of the flag F_D to 1 (S016) and moves the reducing optical system 18 by the correction amount DD in a predetermined direction to locate it at the corrected position Pc (S017). Then, control proceeds to step S008 to perform exposure calculation.

If it is determined in step S015 that the flag F_D is 1 (S015:YES), control proceeds to step S008 because in this case the reducing optical system is already at the corrected position Pc.

It is understood by the above mentioned operation (S015 through S016 and S008 through S012), a properly focus image is obtained under dark ambient light conditions since the reducing optical system 18 is located at the corrected position Pc.

As described above according to the embodiment of the invention, properly focused images can be obtained regardless of the brightness of ambient light, without increasing complexity of the telescope main body. Such an advantage of the embodiment is enhanced when the imaging optical system has a relatively long focal length (e.g., a focal length of more than 800 mm).

In the above mentioned main controlling operation, the driving of the reducing optical system 18 is performed before the release switch 422 is turned ON; however, the driving of the reducing optical system 18 may alternatively be performed after the release switch 422 is turned ON.

However, it is preferable that the driving of the reducing optical system 18 is performed when the photometric switch 421 is switched to ON of as in the above mentioned embodiment because in such a case a time lag from switching to ON of the release switch 422 to the actual shooting can be reduced and thereby likelihood of missing a shooting chance is minimized.

The above mentioned the photometric sensor 71 is located on an outer face of the casing 13 to directly receive external light. That is, the telescope main body 1 is not configured to detect external light in the telescope main body 1, for example, at a rear side of the beam splitter 56. Therefore, reduction of light amount in detecting the intensity of external light can be avoided.

Although the present invention has been described in considerable detail with reference to certain preferred embodiments thereof, other embodiments are possible.

For example, a photometric sensor 72 located to receive a portion of light passed through the objective lens system 11 (see FIG. 6) may alternatively be used to detect intensity of external light (i.e., ambient light). Since the photometric sensor 72 is only required to detect a portion of light passed through the objective optical system 11, the position of the photometric sensor 72 can be selected from various positions. For example, the photometric sensor may be located in the vicinity of a rear surface of the prism unit 5. By use of the photometric sensor 72, it is possible to detect intensity of light nearer to intensity of the object image captured by the CCD imaging sensor 16.

The brightness of the external light may alternatively be detected from output signals of the CCD imaging device 16. in this case, reduction in the number of parts and in manufacturing cost can be attained.

Although in the above mentioned embodiment, the position of the reducing optical system 18 is changed in two steps (i.e., the reference position Ps and the corrected position Pc), the position of the reducing optical system may be changed in three or more steps. In such a case, a plurality of pieces of correction data for moving the reducing optical system 18 to respective proper positions may be prepared based on the spectral luminous efficiency of a user and optical performance of the imaging optical system. The position of the reducing optical system 18 may be controlled in a stepless manner.

Although the telescope main body and the spotting scope according to the present invention have been described referring to the embodiment shown in the accompanying drawings, it is to be understood that the present invention is not limited to the foregoing embodiment, and that the constituents of the telescope main body and the spotting scope may be optionally substituted with different ones which have an equivalent function. Also, an additional constituent may be optionally incorporated.

Furthermore, the present invention can be applied to various other types of telescopes including an astronomical telescope, without limitation to a spotting scope.

The present disclosure relates to the subject matter contained in Japanese Patent Application No. 2003-377602, filed on Nov. 6, 2003, which is expressly incorporated herein by reference in its entirety.

1. A telescope main body, comprising:
an objective optical system;
a focusing system including a focus adjusting member to be manipulated for focusing and a focusing lens which moves along a direction of an optical axis by operation of the focus adjusting member;
an imaging device which captures an object image formed through the objective optical system and the focusing lens;
a beam splitter which splits an optical path through the focusing lens into a first optical path directed to the imaging device and a second optical path directed to an ocular optical system provided in an eyepiece which is detachably attached to the telescope main body;
a focus driving system that relatively moves an image forming position of the object image with respect to a receiving surface of the imaging device;
a detecting system that detects brightness of ambient light; and
a controller that controls the imaging device and the focus driving system,
wherein the controller adjusts the image forming position relative to the receiving surface based on the brightness of the ambient light detected by the detecting system.

2. The telescope main body according to claim 1, wherein the controller adjusts the image forming position relative to the receiving surface to correct a position shift of the focusing lens caused by a fact that a position of the focusing lens determined when focus adjustment of a visual image formed through the ocular optical system by use of the focus adjusting member is attained by a user changes depending on a change of a peak wavelength of spectral luminous efficiency with brightness of the ambient light.

3. The telescope main body according to claim 1,
wherein the controller has a threshold value,
wherein the controller adjusts the image forming position relative to the receiving surface depending on whether the brightness of the ambient light detected by the detecting system is larger than the threshold value.

4. The telescope main body according to claim 1, wherein the detecting system includes a photometric device.

5. The telescope main body according to claim 4, wherein the photometric device is located to detect a portion of light passed through the objective optical system.

6. The telescope main body according to claim 4, wherein the photometric device is located to directly receive external light.

7. The telescope main body according to claim 1, wherein the detecting system detects the brightness of the ambient light based on output signals from the imaging optical system.

8. The telescope main body according to claim 1, further comprising a focus adjusting optical system located on the second optical path.

9. The telescope main body according to claim 8, wherein the focus driving system moves the focus adjusting optical system with respect to the imaging device to relatively move the image forming position with respect to the receiving surface.

10. The telescope main body according to claim 1,
wherein an imaging optical system is formed by optical components including the objective optical system and the focusing lens and located between the objective optical system and the receiving surface of the imaging device, and
wherein a focal length of the imaging optical system is not less than 800 mm on the basis of a 35 mm film.
11. A telescope, comprising:
an ocular optical system;
an objective optical system;
a focusing system including a focus adjusting member to be manipulated for focusing and a focusing lens which moves along a direction of an optical axis by operation of the focus adjusting member;
an imaging device which captures an object image formed through the objective optical system and the focusing lens;
a beam splitter which splits an optical path through the focusing lens into a first optical path directed to the imaging device and a second optical path directed to the ocular optical system;
a focus driving system that relatively moves an image forming position of the object image with respect to a receiving surface of the imaging device;
a detecting system that detects brightness of ambient light; and
a controller that controls the imaging device and the focus driving system,
wherein the controller adjusts the image forming position relative to the receiving surface based on the brightness of the ambient light detected by the detecting system.
